(19) United States
(12) Patent Application Publication
(10) Pub. No.: US 2011/0311603 A1
(43) Pub. Date: Dec. 22, 2011

(54) Materials, Methods, and Apparatuses for Controlling Pests

(75) Inventor: Kirk Lucas, Santa Fe, NM (US)

(73) Assignee: KILTRONX ENVIRO SYSTEMS, LLC, New York, NY (US)

(21) Appl. No.: 13/110,867

(22) Filed: May 18, 2011

Related U.S. Application Data
(60) Provisional application No. 61/345,900, filed on May 18, 2010.
(60) Provisional application No. 61/417,103, filed on Nov. 24, 2010.

(51) Int. Cl. A01N 25/34; A47G 9/08; B32B 37/02; A01P 7/02; D06C 29/00; D05B 11/00; A01N 59/00; A01P 7/04; A47G 9/00; B32B 37/14

(52) U.S. Cl. 424/411; 5/482; 5/413 R; 156/73.1; 156/148; 28/167; 112/117; 424/724

(57) ABSTRACT

A bedding cover treated with a pesticide. The cover repels or kills pests such as bedbugs, dust mites, ticks, fleas, and other pests for use in bedrooms, hotels, motels, pet beds, and the like. The cover is preferably waterproof and disposable. Also a quilted material for controlling pests, and methods of manufacture thereof. The material encloses and controllably releases a pesticide only to desired locations. The material may be formed into many uses, such as a bedding cover, a bag insert, a luggage liner, a container liner, or a tape.

### CROSS-REFERENCE TO RELATED APPLICATIONS

This application claims priority to and the benefit of the filing of U.S. Provisional Patent Application Ser. No. 61/345,900, filed May 18, 2010, entitled “Insect Repellant Material” and U.S. Provisional Patent Application Ser. No. 61/417,103, filed Nov. 24, 2010, entitled “Materials, Methods, and Apparatuses for Controlling Pests”. The specifications and claims thereof are incorporated herein by reference.

### BACKGROUND OF THE INVENTION

1. Field of the Invention (Technical Field):

Embodiments of the present invention relate to materials, articles, methods, and apparatuses for controlling pests such as bed bugs, such as a preferably disposable bedding cover which is used to prevent and eliminate the presence of pests such as bedbugs or dust mites in bedrooms, hotels, motels, pet beds, and the like. The present invention also relates to a preferably quilted insect repellant material.

2. Description of Related Art:

Note that the following discussion may refer to a number of publications by author(s) and year of publication, and that due to recent publication dates certain publications are not to be considered as prior art vis-à-vis the present invention. Discussion of such publications herein is given for more complete background and is not to be construed as an admission that such publications are prior art for patentability determination purposes.

### SUMMARY OF THE INVENTION

An embodiment of the present invention is a bedding cover comprising a substantially waterproof material, an adhesive applied to the material, a chemical applied to the adhesive for repelling and/or killing one or more pests, and a securing mechanism for securing the bedding cover to bedding; wherein the bedding cover is disposable and/or recyclable. The adhesive is preferably soy based and/or formaldehyde free. The chemical is preferably substantially all-natural and/or EPA approved, and is preferably applied in powder form. The material preferably comprises viscose. The securing mechanism preferably comprises elastic or a drawstring, wherein the drawstring comprises a bamboo-based fabric. The securing mechanism optionally comprises a zipper in which case the bedding cover completely encloses the bedding. The bedding cover preferably further comprises a natural ink which biodegrades or changes color after a desired period of time.

Another embodiment of the present invention is a method of repelling or killing one or more pests, the method comprising the steps of applying an adhesive to a substantially waterproof material, applying a pesticide to the adhesive, wherein the material, adhesive, and pesticide forms a bedding cover, drying the bedding cover, securing the bedding cover to bedding, and disposing of or recycling the bedding cover after a desired time period or number of uses. The step of applying the adhesive preferably comprises spraying the adhesive on the material. The step of applying the pesticide preferably comprises dusting on the pesticide in powder form and preferably comprises applying approximately one pound of pesticide per 1000 square feet of material. The securing step preferably comprises tightening an elastic or drawstring. The method optionally further comprises the step of enclosing the bedding in the bedding cover, in which case the securing step preferably comprises zipping the bedding cover closed. The method preferably further comprises the step of printing a biodegradable ink on the bedding cover, the ink changing color after the desired time period. The method optionally further comprises the step of producing a disposable shopping cart handle cover from the recycled bedding cover.

Another embodiment of the invention is a material for controlling pests, the material comprising a porous fabric sheet, a second fabric sheet, and a batting in contact with a pesticide, the batting quilted or bonded between the porous fabric sheet and the second fabric sheet, wherein powder comprising the pesticide is controllably releasable through the porous fabric sheet. The pesticide preferably comprises food grade diatomaceous earth. The porous fabric sheet and/or the second fabric sheet preferably comprise polyester or polypropylene, and are either woven or non-woven. The second fabric sheet is porous or non-porous to the powder. The material is optionally sealed around all edges, or alternatively is open along at least a portion of one or more edges, thereby permitting pests to contact the batting and the pesticide. This material optionally comprises a carpet pad. The material is preferably sufficiently inexpensive to be disposable. The material may be configured to at least partially surround bedding. The material of preferably further comprises a fastener for fastening the material to an object. The fastener is preferably selected from the group consisting elastic skirt, elastic band, drawstring, Velcro®, plastic or metal snaps, toggle pulls, magnets, ties, tape, glue, adhesive, snaps, or hook and loop fasteners. The fastener preferably permits pests to come into contact with an outside surface of the porous fabric layer. The object is optionally selected from the group consisting of bedding, luggage, briefcase, tote bag, purse, bag, backpack, truck container, and sleeping bag. The material optionally comprises an adhesive and is configured as a tape. The material is preferably designed so that the pesticide will continue to be released throughout a predetermined lifetime of the material. The material may at least partially comprise Tyvek® or a satin or satin-like material.

Another embodiment of the invention is a method of manufacturing a material for controlling pests, the method comprising disposing a pesticide on batting and quilting the batting between two fabric sheets, wherein at least one of the fabric sheets is porous to the pesticide. The quilting step is preferably performed using a quilter, a seam welder, or an ultrasonic bonding machine. The disposing step preferably comprises spraying a liquid or powder pesticide on the batting. The method preferably comprises the at least one porous fabric sheet controllably releasing the pesticide, preferably ensuring that pesticide will continue to be released throughout a predetermined lifetime of the material. The method preferably further comprises sealing the material around at least a portion of the edge of the material. The method preferably further comprises disposing a fastener on the material, and the configuration of the fastener preferably permits pests to access an outside surface of the at least one porous fabric sheet.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1A shows an example of roll manufacturing of and embodiment of fabric of the present invention.

FIGS. 1B-1E are different examples of fabric.

FIG. 2A shows an elasticized embodiment of the present invention.

FIG. 2B shows an embodiment of the present invention with a zipper-type closure.

FIG. 2C shows an embodiment of the present invention with a zipper-type closure for encasing pillows.

FIG. 3A shows a drawstring embodiment of the present invention for pet beds.

FIG. 3B shows an embodiment of the present invention with a zipper for enclosing a pet bed.

FIG. 4A is a cutaway view of an embodiment of a bedding cover.

FIG. 4B is a top view of the bedding cover of FIG. 4A.

FIG. 4C shows the bedding cover of FIG. 4A in place around bedding.

FIG. 5 shows a tote bag liner in accordance with the present invention.

FIGS. 6A and 6B show side and end views respectively of a truck container liner in accordance with the present invention.

FIG. 7 is a schematic of a luggage liner in accordance with the present invention.

FIG. 8 is a schematic of a backpack insert in accordance with the present invention.

FIG. 9 is a schematic of a sleeping bag liner in accordance with the present invention.

FIGS. 10A and 10B are cross sectional and top views of a blister tape in accordance with the present invention.

FIG. 11 shows various views and widths of a tape in accordance with the present invention.

FIG. 12 shows an application of the tape of the present invention for an electrical outlet cover.

### DETAILED DESCRIPTION OF THE INVENTION

As used throughout the specification and claims, the term “pest” means any insect, bug, arachnid, germ, disease, virus, or bacteria, including ants, armyworms, bedbugs, caterpillars, chinch bugs, cutworms, fire ants, fleas, lice, mites, ticks, cockroaches, silverfish, spiders, boxelder bugs, crickets, stink bugs, sow bugs, pill bugs, ground beetles, earwigs, millipedes, centipedes, scorpions, and the like, and their eggs.

As used throughout the specification and claims, “bedding” means bed, futon, mattress, mattress pad, box spring, mattress or cushion in a semi truck sleeper cab, pillow, pet bed, airline seat, automobile seat, theater seat, baby mattress, sofa, chair, loveseat, ottoman, cushion, upholstered furniture, and the like.

As used throughout the specification and claims, the term “pesticide” means diatomaceous earth, insecticide, poison, or any other material or chemical which repels and/or kills pests by any means, including but not limited to chemical, biological, mechanical or physical means.

Embodiments of the present invention relate to materials, articles, methods, and apparatuses for controlling pests such as bed bugs. The pests are preferably killed, both immediately and for a time thereafter, and reproduction of eggs is preferably prevented, by setting traps. A human may be used as a lure to attract the pest. Pests typically hide under and within bedding, or in other locations, to avoid detection. In order to feed, the presence of a human or other animal lures the pest across, through, over, under or into a bedding cover or other article which is treated with a pesticide such as a powder in accordance with embodiments of the present invention. Fabric of the invention can cover or be attached to any and all surfaces where pests may travel or hide. Once the pest is trapped by or otherwise contacts an article of the present invention, the pesticide kills the pest. In addition, if any eggs have been laid, as soon as they hatch, the pests will also come in contact with the material, thus stopping the reproductive cycle. If a new pest is introduced into the environment, the same thing occurs. It is preferable that humans or pets never come into contact with the material; thus in some embodiments it is disposed on a bottom layer under a water/powder proof and bite proof layer.

Pesticides

The pesticide used is preferably all-natural (or mostly all-natural), safe, and is EPA approved. A preferred chemical pesticide is DIATECT® III, which comprises pyrethrin, diatomaceous earth (DE or silica), and Piperonyl Butoxide. The chemical typically is available as powder, and is preferably dusted on the material surface, or optionally diluted in water or another liquid before spraying. One pound of chemical is preferably used to treat 1000 square feet of material, and the duster or sprayer (if used) is preferably adjusted to provide that (or another desired) amount of coverage. The sprayer may be electrically operated, mechanically operated or manual, and may comprise a dust pump sprayer, powder mill duster, wide area applicator, Maruyama gas duster, lawn and garden sprayer, water pump pressure sprayer, compressor sprayer, wheel pump sprayer, RL Flomaster Acid Resistant Sprayer, Chapin Sprayer, or the like. Other methods of applying the chemical to the material include rolling it on, or immersing the material in the chemical.

Because it can be difficult for the chemical, whether in powder or liquid form, to adhere to the material, prior to applying the chemical an organic spray adhesive is preferably applied to the material. The glue or adhesive is preferably natural or “green”, contains no formaldehyde and is RHOS compliant and low VAC (Volatile Organic Compound). The adhesive preferably is soy starch based, low mist, bonds fast, and has high temperature resistance. The adhesive preferably dries quickly, resists moisture and is transparent when dried. Although any adhesive may be used, two examples of adhesives are SIMALFA® or Soyad®.

Although DIATECT® III, pyrethrin, other chemicals or insecticides, or pool-grade diatomaceous earth may be used, the pesticide of the present invention preferably comprises food-grade diatomaceous earth, which is a “non-chemical” that is EPA registered and FDA approved for animal consumption, especially when the article comes into contact with humans or food. It is preferable that the pests are killed via a physical or mechanical and not chemical mechanism, although any mechanism may be employed.

Construction

Embodiments of the present invention comprise a fabric article. The fabric may comprise any material, including but not limited to a paper-type fabric or a 50% polyester-50% rayon fabric. The material preferably comprises recycled materials and is recyclable. The cover material preferably comprises 65% polyester and 35% viscose for waterproofing. The density is preferably 95×95, although any density may be used. The material optionally comprises nylon/viscose/polyester (a nylon fiber with high tensile strength and resilient synthetic polymers, which has desirable properties including strength, elasticity, resistance to abrasion and chemicals, low moisture absorbency, and high durability).

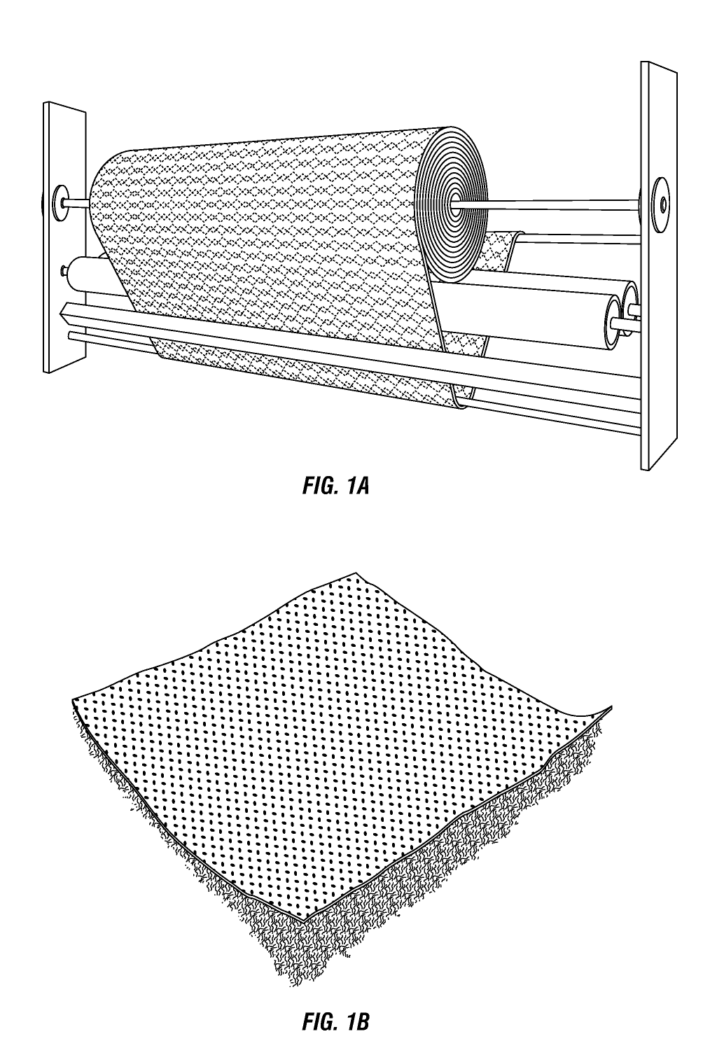

The fabric may comprise any number of layers. The batting material or fill is preferably treated with the pesticide, and preferably also acts as a nesting material. The pesticide, typically in powder or liquid form, may be sprayed or otherwise disposed on any or all sides, surfaces, or layers of the fabric, preferably on an interior surface (that is, the surface which touches the bedding, not the person or pet), or on the batting or fill layer. One or more surfaces or layers may release a powder comprising the pesticide, which release is partially controlled by the densities, porosities, or weaves of raw products (e.g. woven or non-woven) used to make the fabric and/or roller pattern designs (i.e. the quilting pattern). The powder may be released only on one side of the fabric in some embodiments, thereby limiting human contact with the pesticide. Combinations of layers, densities, and patterns may be varied based on the application. Examples of different fabrics and patterns are shown in FIG. 1. Some embodiments of the fabric of the present invention is designed with one or more sides open (not finished or sewn) so that bedbugs can enter the fabric, such as for hiding. The fabric preferably comprises one or more layers. For example, one three layer embodiment comprises two outer layers of polypropylene and a center layer of batting material; see for example FIG. 1E.

In certain embodiments, for example a mattress cover, the fabric comprises two fabric sheets with different densities. A “derma layer” on top, designed to be in contact with a person, is preferably sufficiently dense so as not to be porous. Thus the pesticide preferably does not penetrate the derma layer. The bottom sheet is preferably porous; agitation and the pressure of the person sitting or lying on the cover preferably forces the pesticide through the bottom sheet, thus killing any pests in the mattress. Alternatively, in some embodiments, the fabric is saturated with pesticide, and thus pressure is not needed to release it. The amount of pesticide used, the porosity of the bottom sheet, and the quilting pattern (including the amount of sheet area between quilt stitches) determine the amount of pesticide dispersed through the bottom sheet. For other applications, such as packaging or shipping, both fabric sheets may be porous. In these applications, pressure or agitation forces the pesticide through the fabric sheet. Any size sheet may be constructed for a desired application. The density and porosity of the sheet material, together with the quilting pattern, is preferably selected to control the amount and area of dispersal of pesticide or powder, preferably minimizing or otherwise limiting airborne dispersal and exposing only desired locations to the pesticide, unlike pesticide powder which is just spread on a surface out in the open. Although food grade DE is nontoxic to humans, it cannot be inhaled for an extended period of time. In addition, controlled release of the pesticide ensures that sufficient pesticide will be left to be released over the entire life of the product.

In some applications it is desirable that the pesticide powder filters onto an object being covered, such as a mattress, bedding, sleeping bag, back pack, or luggage. In those applications it is preferable that the lighter fabric permits at least some of the pesticide powder to filter out of the sheet. In such case, after quilting a thin layer of preferably recycled plastic is preferably disposed on the lighter fabric to keep the powder in place during manufacturing and shipment. The plastic layer may be removed by the consumer or user prior to use.

Manufacturing

Embodiments of the present invention comprise an insect repellant material and method of manufacture thereof. One manufacturing method comprises the following steps:

A fabric, such as cloth, paper, bamboo, or recycled fabric, is evenly powder coated with pesticide powder by a hopper.

The fabric is preferably inspected for even distribution of pesticide.

As the treated fabric continues down a processing table a lighter grade fabric (e.g. 45-65 gm) is applied on top of the treated fabric. The lighter fabric preferably has a light glue applied every 12″ to keep it in place.

The fabric is then fed through a welder, such as the T500 Universal welding system (Miller Weldmaster Corp.), which seams the two fabrics together, quilting and pocketing the pesticide powder.

If the product requires a drawstring instead of tape (such as for a pet bed) the product is taken to the sewing station for the string and seams to be sewn.

A surger sews the sides together (preferably at least at a rate of one every three minutes).

Tags are applied (EPA, reg, expiration tags).

The tape is added at the end of the cover or case, if applicable.

The completed material is folded at the folding station as necessary.

The folded material is sent to the shrink-wrapper (1-2 seconds).

Another method for making a sheeting material is as follows. A strip or sheet of preferably porous filler material (such as a polyester fill) or batting fabric, preferably approximately ½″-1″ thick, is saturated, sprayed, or at least partially impregnated with a powder or liquid comprising a pesticide. The pesticide preferably comprises food grade diatomaceous earth powder. The powder is preferably disposed on the filler material with a spray gun, and coats the filler material with a powder thickness of less than approximately 1/16″. However, the amount of pesticide used may be varied depending on the application. The impregnated filler material is then preferably disposed between two sheets of fabric. The fabric may comprise any material, but is preferably disposable and preferably comprises polypropylene or polyester fabric. The multilayer sheet is then preferably fed through a quilting machine and stitched together. The quilt stitching may be in any pattern depending on application, such as diamonds, parallel lines, or any other design that holds the pesticide in place. For example, for a tape to be applied across a vertical wall, the stitching may be parallel to the long side of the tape to prevent all of the pesticide from sinking to the bottom edge of the tape due to gravity. Similarly, a vertical tape may comprise cross-stitching. This sheeting material may optionally be used in any of the embodiments or applications disclosed herein, and may be fabricated for any use in any size or shape.

In the above methods, after treatment with the pesticide, the fabric of the present invention is preferably bonded or stiched together. Ultrasonic bonding machines or quilting machines, such as one shown in FIG. 1A, preferably comprising custom rollers, press quilted designs into the fabric as it is bonded during mass production of rolls of the fabric. Embodiments of the fabric can be fabricated in rolls up to 140 inches in width and up to three hundred yards in length. The quilting of the fabric forms pockets for holding the pesticide and keeping it evenly distributed within the fabric. All layers of the fabric are preferably bonded together simultaneously. Typically, quilted materials are used to absorb something, for example a liquid. In contrast, the quilting of the present invention controls the release of the pesticide.

Applications

Once bonded, embodiments of the fabric may be cut and sewn or otherwise fabricated into multiple products of any size or dimension, including but not limited to tape, mattress covers, box spring covers, furniture leg booties, container liners, box and other shipping liners, shelving liners, bag liners, purse liners, sleeping bag liners, tote bag liners, squares or cubes (preferably 2 inches per side) for placement in packing, shipping, or storage containers, luggage liners, carpet padding, hand bag liners, backpack and knapsack liners, electrical outlet cover liners, ventilation grill liners, pipe wrapping, insulation, sound proving materials, lighting fixture tape, table and chair products, sofa and furniture construction, cushion liners, curtain liners, bedding products, truck liners, and automobile applications. An elastic skirt or band or a drawstring may optionally be sewn on or otherwise attached to the fabric depending on the application. If a drawstring is used, it preferably comprises a biodegradable bamboo fabric. In addition to a drawstring or elastic, the fabric may be affixed to the desired object by sewing or by using any type of fastener, such as Velcro®, plastic snaps, toggle pulls, magnets, ties, tape, glue, adhesive, snaps, hook and loop fasteners, insertion, or simply laying in place.

One embodiment of the present invention is a bedding cover which is treated with a pesticide for repelling or killing pests which typically infest bedrooms in homes, motels, hotels, pet beds (such as dog beds or cat beds), and other locations. The cover can be made for military use and for use in prisons and jails. The cover of the present invention is preferably breathable but waterproof, thus not allowing bodily fluids to penetrate and keeping the bedding sanitary. The cover is preferably disposable and is preferably fire retardant and/or flame resistant and preferably meets U.S. and California Fire Code standards. The cover is preferably a fitted cover which attaches via elastic or drawstring to the bedding, although the cover may optionally totally encase the bedding and be, for example, closed using a zipper or other fastening mechanism.

The covers of the present invention are preferably inexpensive so they may be disposed of or recycled after each use. However, the covers may alternatively be used for up to six to eight months and then disposed of or recycled. Logos or other designs or instructions are preferably printed on the covers using a soy ink which biodegrades or otherwise turns color after a desired period of time (for example, six months), thereby indicating to the user that the cover has expired and must be replaced. The covers may be recycled, for example, using known heat processes into, for example, disposable shopping cart handle covers.

The regular use of the cover of the present invention means that repeated dustings or other applications of pesticide, which is typically what is performed by hotels and motel rooms, are no longer necessary. In addition, the product is preferably hypo-allergenic and/or anti-allergenic.

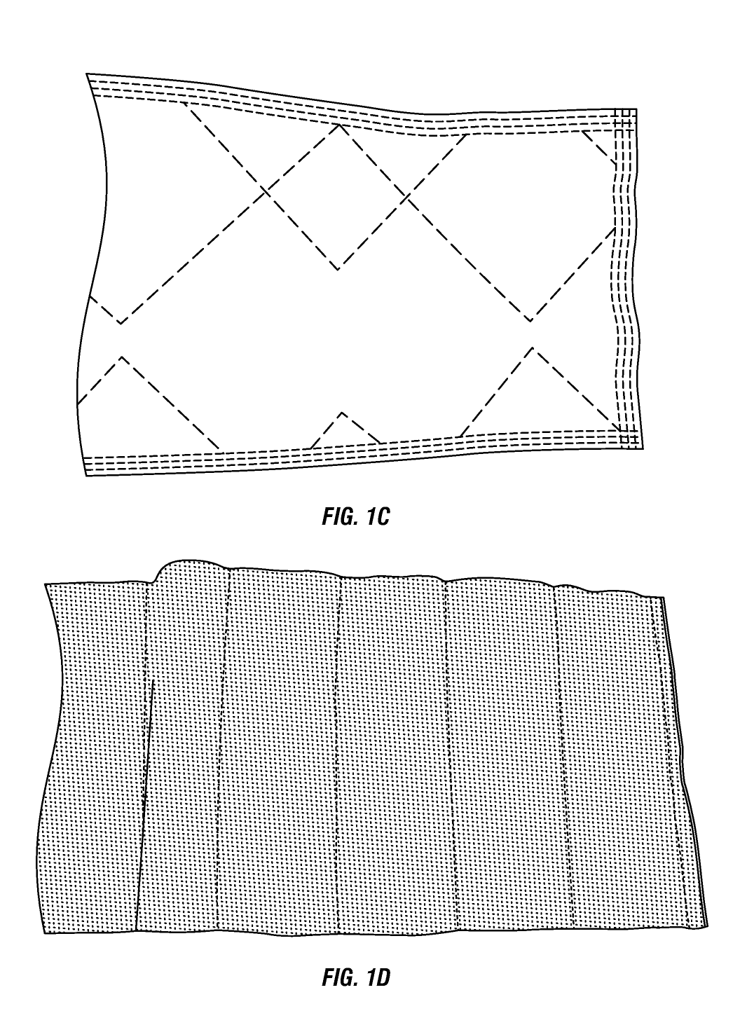

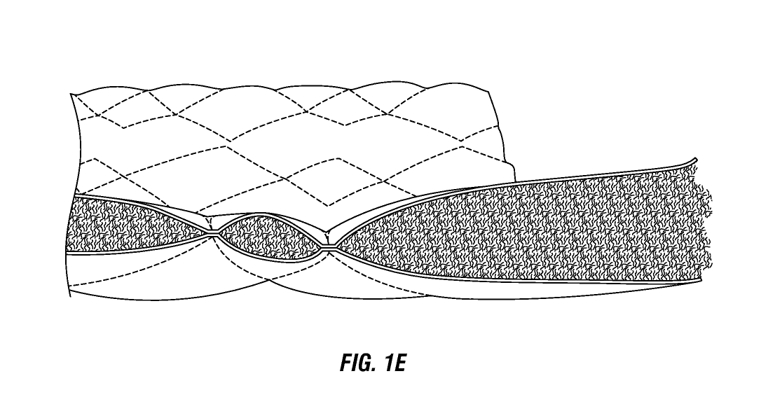

FIG. 2A shows an embodiment of mattress cover 10 comprising elastic edge 20 being disposed over mattress 30 and optionally box spring 40. FIG. 2B shows an alternative embodiment of mattress cover 50 comprising zipper 60 totally encasing mattress 30. FIG. 2C shows an embodiment of pillow cover 70 comprising zipper 80 totally encasing pillow 90. FIG. 3A shows an embodiment of pet bed cover 100 comprising drawstring 110 being disposed over pet bed 120. FIG. 3B shows an embodiment of pet bed cover 130 comprising zipper 140 totally encasing pet bed 120.

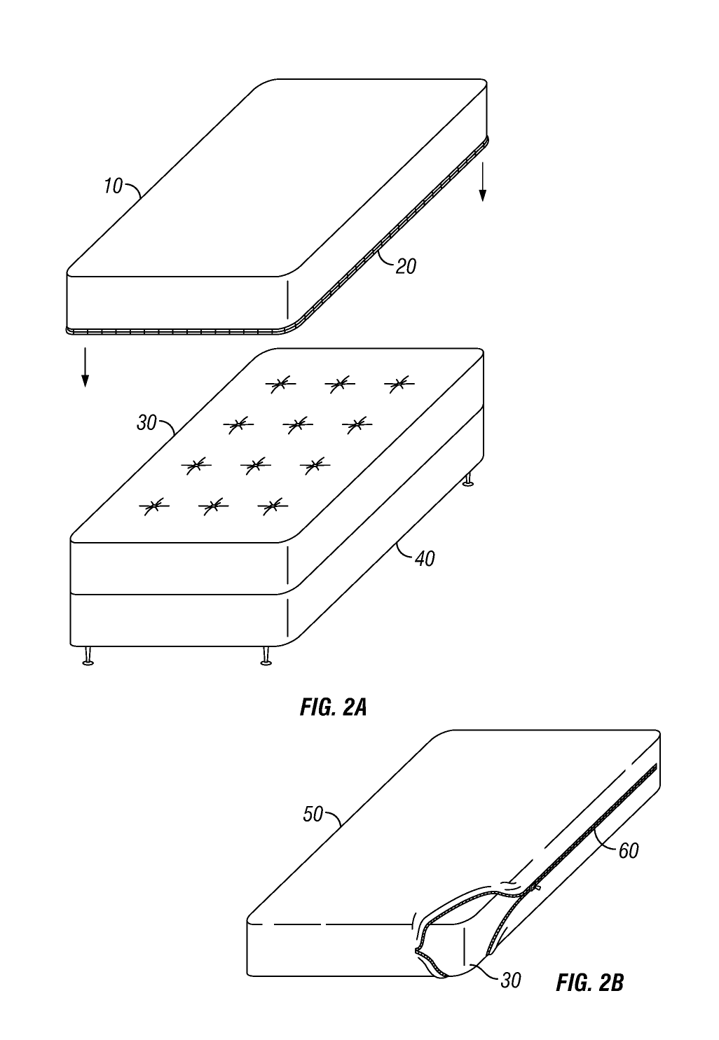

An embodiment of the present invention is bedding cover 145, comprising top surface 150, batting 160, and bottom surface 170, as shown in FIG. 4. The inside surface of bottom surface 170 and/or batting 160 is preferably sprayed with adhesive 180 and pesticide 175. Bottom surface 170 preferably comprises lighter weight polypropylene than top surface 150, allowing pesticide to be released. Although the cover may optionally completely enclose bedding 190, such as a mattress, pet bed, or theater seat, the cover is preferably secured with tape, elastic 195, drawstring 172, snaps, Velcro®, or other fastening means which leaves open spaces 200 so that the pest can get under the cover, where it is trapped, and come into contact with the pesticide. For example, if tape adhesive is used it is preferably staggered to allow an opening for the bugs to enter. A drawstring enables the cover to be adjustable to fit any similar size bedding, particularly for such bedding as a pet bed or theater seat.

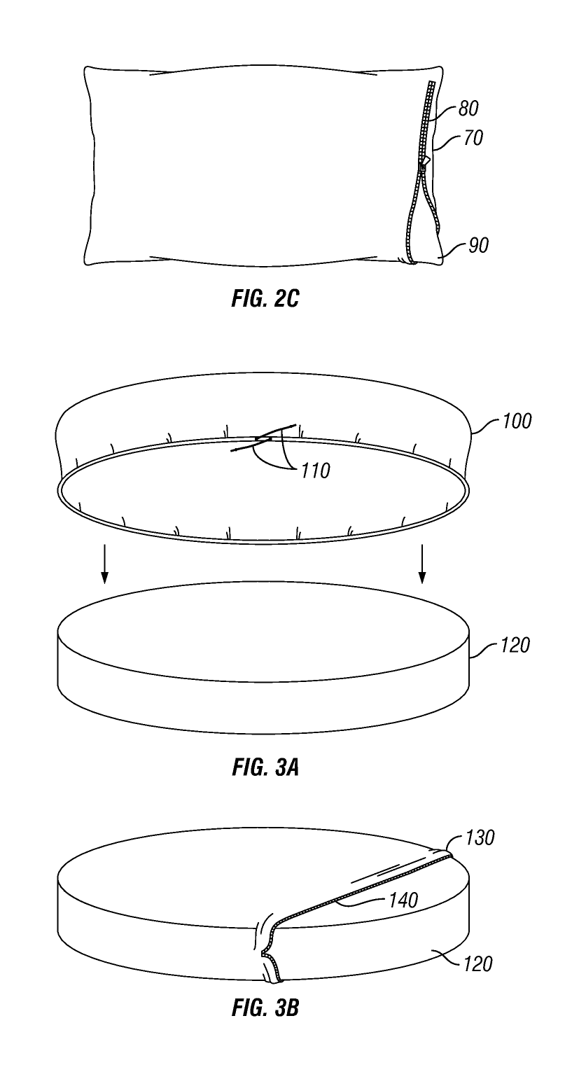

Another embodiment of the present invention is a tote bag 210, as shown in FIG. 5. The bag optionally comprises a zipper (shown) or magnetic bar along the rim which seals the bag tightly shut to prevent pests from entering or leaving. Removable liner 220, preferably comprising a liner or the sheeting material disclosed herein, is inserted into the bag and snapped (via snaps 230) onto or slide into the inside bottom and/or sides of the bag, which leaves an opening for a pest to crawl into the trap, thereby killing it with the pesticide. Pesticide may leak out of liner 220, but only in barely noticeable quantities. This closure/insert system may be used in many types of bags, such as shopping bags, purses, handbags, backpacks, storage and/or shipping bags and containers, luggage, and the like. Tote bag 210 may comprise a light material so that optionally can fold into its own front pocket for storage.

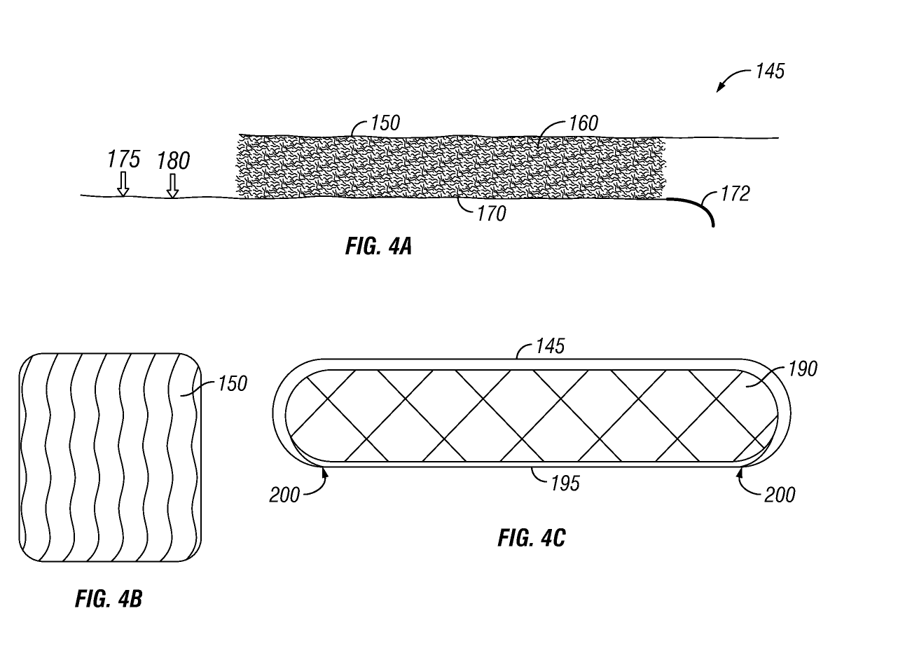

Embodiments of the present invention may be used inside shipping containers, semi-trailer or other trucks, or freight train cars. Liners in accordance with the present invention will protect the freight from being infested or re-infested with bedbugs as the freight is loaded and unloaded. Embodiments of container liners preferably are sold in rolls adjustable to the different lengths of containers. As shown in FIG. 6, liner 240 can be cut and one or more strips of tape 250, 250′, 250″ placed to keep the sheeting in place on a side inside container 235. The tape may comprise tape of the present invention, as described below. The sheeting preferably comes pre-taped on the top, center and bottom. The sheeting preferably comprises a durable polypropylene with the pesticide “sandwiched” between the layers. The liners may optionally be available in standard sizes to be easily installed. The liners are preferably disposable and may last as long as a year. Because pests such as bedbugs can be killed by heating and/or freezing, a shipping container may be subjected to a temperature extreme enough to kill a desired pest, then fitted with liners in accordance with the present invention in order to prevent re-infestation. Such tape or liners may also be used in warehouses.

Other embodiments of the present invention comprises a window treatment, bed dust ruffle, or other article touching the floor on which fabric material as described above is sewn on the inside (i.e. away from view). Preferably the top 6″ and bottom 6″ of the article is covered with the sheet to act as a barrier to pests. The sheet may be attached to furniture legs, pipes, outlets, outlet covers, fixtures, or even placed inside a wall or inside a piece of furniture, such as a sofa.

Another embodiment of the present invention comprises a composite rug or carpet pad. The pad preferably comprises a waterproof, dust resistant top surface such as polypropylene. The carpet or rug is preferably disposed directly on this top surface. The interior of the pad preferably treated with diatomaceous earth. The bottom layer of the pad preferably comprises polypropylene and is preferably perforated to permit pests to enter the interior, thereby contacting the diatomaceous earth which kills them. If the pad gets wet, the diatomaceous earth will continue killing pests after it dries out.

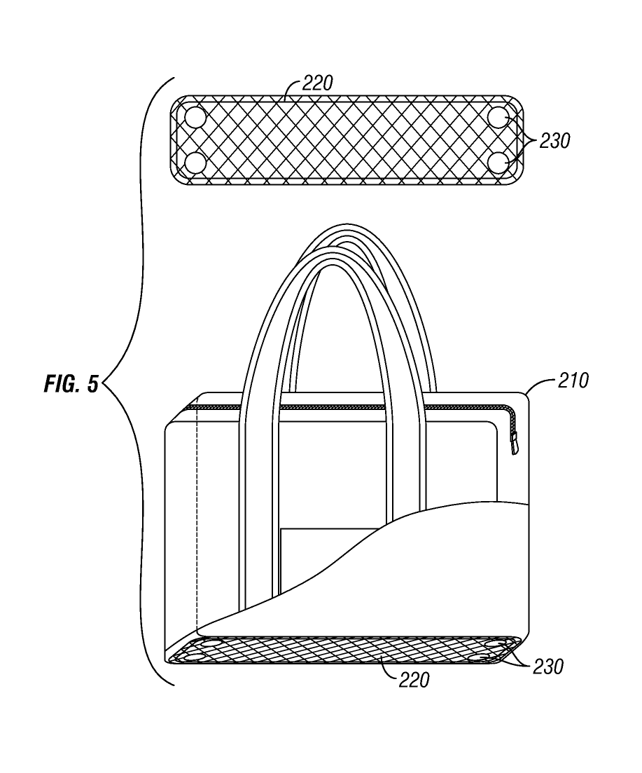

FIG. 7 shows a luggage liner in accordance with the present invention. The liner comprises quilted side 260 which is attached to but smaller than inside layer 280. The liner is attached to the inside of luggage, with quilted side 260 facing outward, by tape 270. Tape 270 preferably is applied to corners of inside layer 280 only, or is otherwise staggered, allowing pests to enter quilted side 260 and come into contact with the pesticide.

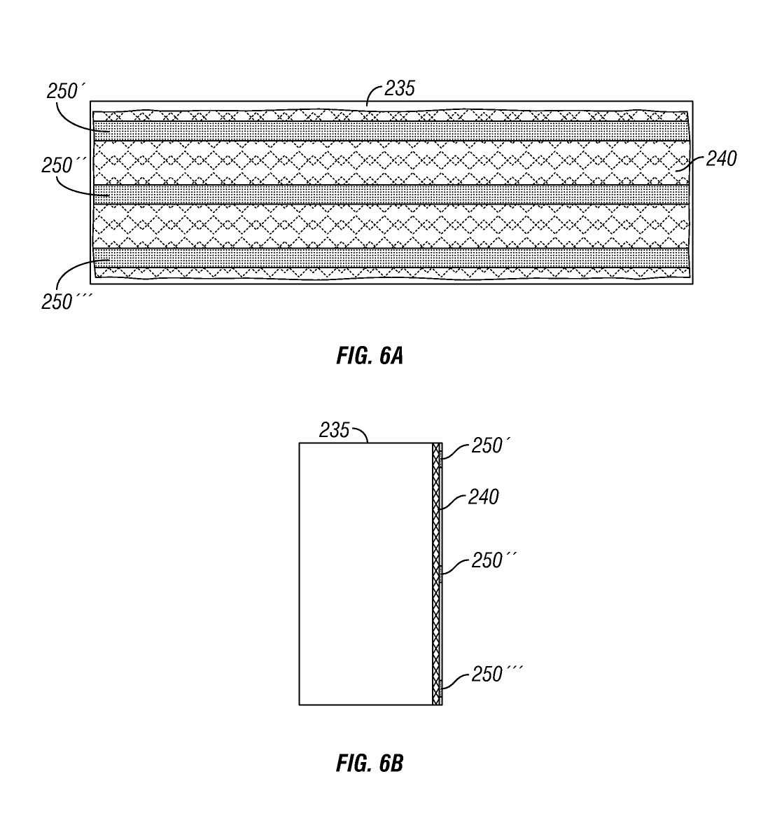

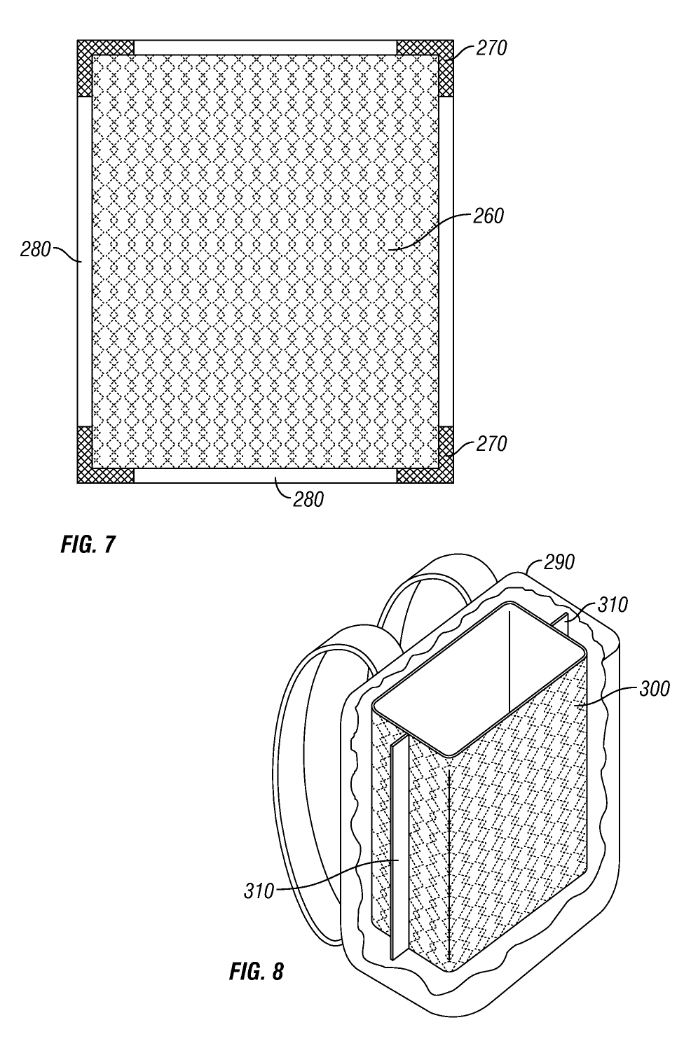

FIG. 8 is a schematic of an insert 300 for a backpack 290, which is kept in place by tape flaps 310. Similar to the luggage liner of FIG. 7, the quilted side of insert 300 preferably faces away from the contents of backpack 290. Similarly, FIG. 9 is a schematic of a liner 330 for bedroll or sleeping bag 320.

Other embodiments of the present invention are products preferably designed keeping in mind where pests hide long term, since certain pests such as bedbugs can live up to one year between feedings. In one embodiment, tape comprises pockets for holding and dispersing the pesticide, optionally in addition to comprising Tyvek® or a satin or satin-like material to attract pests such as bedbugs, and optionally comprises treated cedar for closets and drawers. The tape can be applied to dark corners, headboards, behind picture frames, closets, drawers, curtains, window treatments, and bedskirts. An embodiment of the tape preferably comprising a waterproof or water resistant substrate and adhesive may be used around plumbing, and the pesticide will preferably dry out if it gets wet, even if the tape is disposed inside a wall. For vents or air ducts, the tape is preferably four inches wide and preferably comprises a one-inch exposed area facing outward to prevent the pests from entering the room after coming into contact with the pesticide. For electrical fixtures such as wall sockets or light fixture covers, the tape substrate preferably comprises a rubber-like material similar to that of existing electrical tape. In all embodiments, the present invention will preferably meet fire codes.

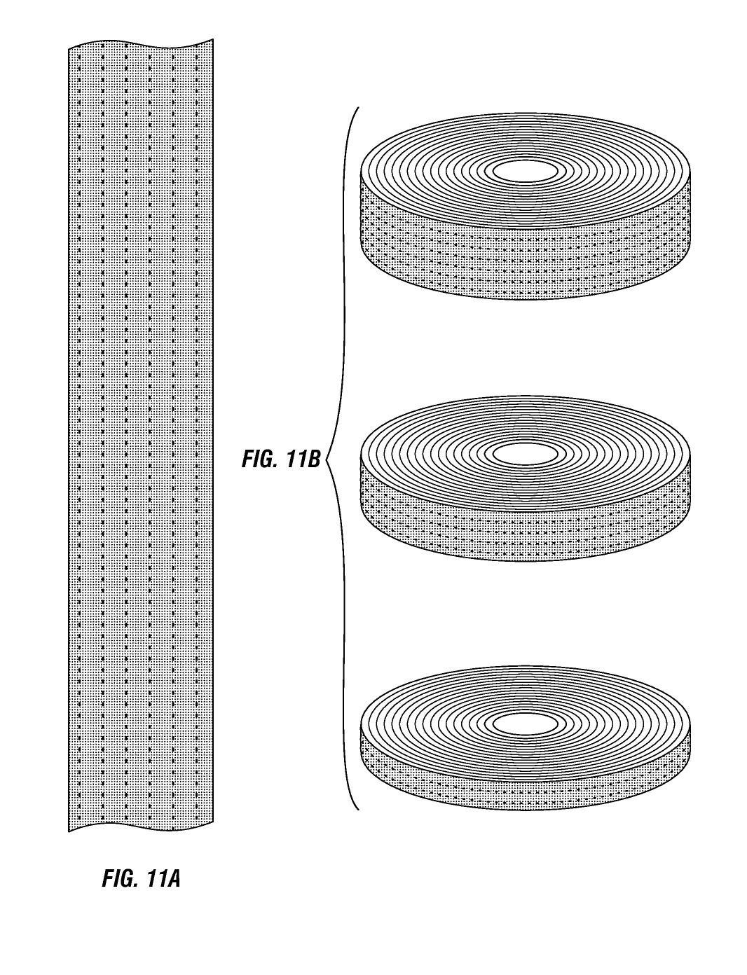

An embodiment of the tape comprises heavy construction with an adhesive that will stick to wood and all metals. The substrate preferably comprises a dense paper or a polyester. The top of the tape optionally comprises Tyvek®, satin, synthetic satin, or a satin-like material which can attract pests, which are subsequently trapped or lured to the corners and fabric. Alternatively, a tag comprising said material may be attached to the tape, or bedding cover, to attract pests which are subsequently killed. The tape preferably comprises small perforations so the pests can enter the interior of the tape, which is preferably at least partially filled with the pesticide. As shown in FIG. 11, the tape may comprise any surface material and width.

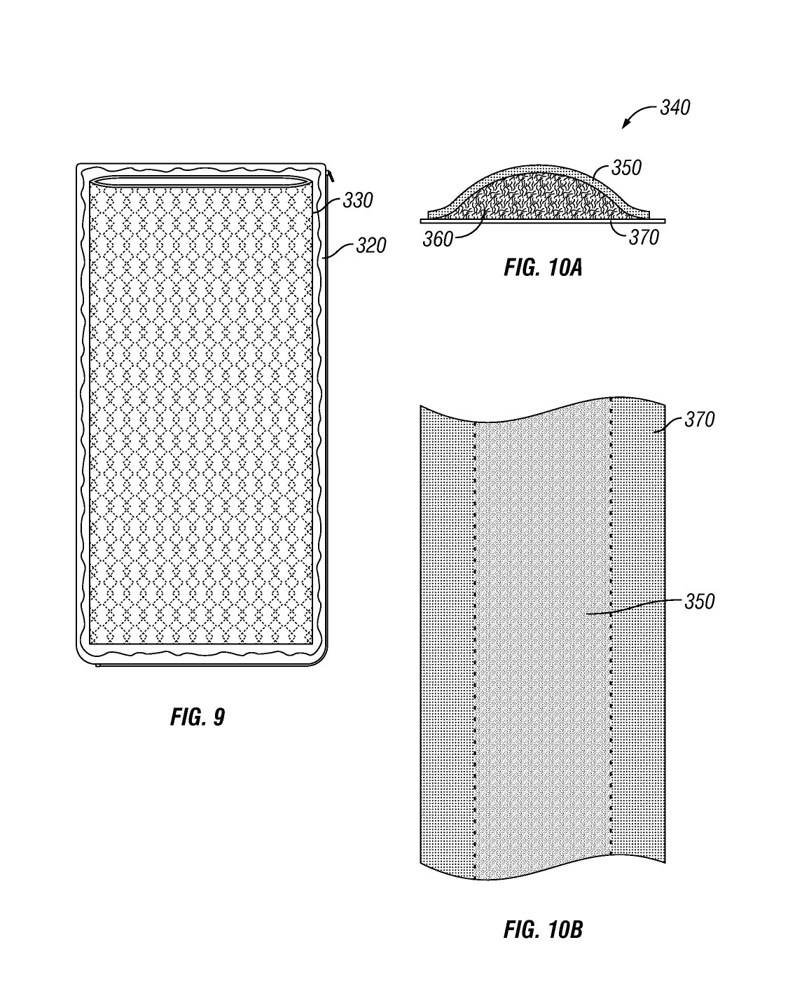

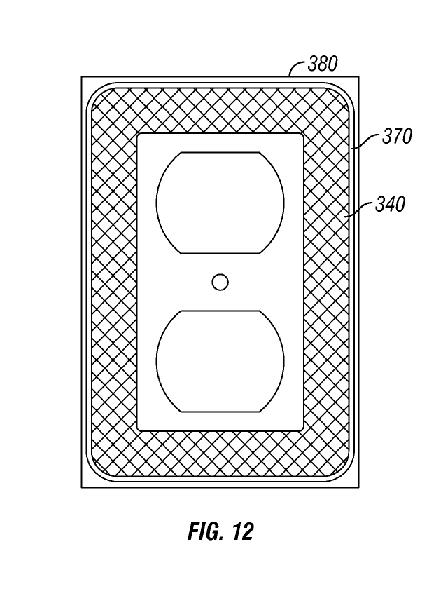

Another embodiment of the present invention is blister tape 340 comprising pesticide powder or pesticide treated batting 360, pocketed inside, as shown in FIG. 10. Blister tape 340 may be of any width or length to fit different locations. but is preferably 1″ to 2″ wide. Blister tape 340 preferably comprises double stick tape 370, such as that made by 3M (or is similar to plastic tape used in diapers) and approximately 5 g per inch of pesticide powder quilted under a cheese cloth or other light fabric coating 350, which is then preferably covered with a thin plastic sheet to keep powder from escaping. The plastic cover and backside of the double stick tape is preferably removed by the user prior to use. The tape may then be placed where needed to prevent the migration of pests, such as bedbugs or lice. Such locations include around headboards, along bed frames, inside drawers and closets, around plumbing, and surrounding electrical outlets on the back side of outlet cover 380, as shown in FIG. 12.

In any of the embodiments herein, at least a portion of the tape, liner, or sheet may optionally comprise Tyvek® or a satin or satin-like material or a woven material for luring the pests inside bedding covers or inside another trapping design.

Although the invention has been described in detail with particular reference to the described embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A material for controlling pests, the material comprising:
a porous fabric sheet;
a second fabric sheet; and
a batting in contact with a pesticide, said batting quilted or bonded between said porous fabric sheet and said second fabric sheet;
wherein powder comprising said pesticide is controllably releasable through said porous fabric sheet.

2. The material of claim 1 wherein said pesticide comprises food grade diatomaceous earth.

3. The material of claim 1 wherein said porous fabric sheet and/or said second fabric sheet comprise polyester or polypropylene.

4. The material of claim 1 wherein said porous fabric sheet and/or said second fabric sheet are woven or non-woven.

5. The material of claim 1 wherein said second fabric sheet is porous or non-porous to said powder.

6. The material of claim 1 wherein said material is sealed along all edges.

7. The material of claim 1 wherein said material is open along at least a portion of one or more edges, thereby permitting pests to contact said batting and said pesticide.

8. The material of claim 7 wherein said material comprises a carpet pad.

9. The material of claim 1 wherein said material is sufficiently inexpensive to be disposable.

10. The material of claim 1 configured to at least partially surround bedding.

11. The material of claim 1 further comprising a fastener for fastening said material to an object.

12. The material of claim 11 wherein said fastener is selected from the group consisting elastic skirt, elastic band, drawstring, Velcro®, plastic or metal snaps, toggle pulls, magnets, ties, tape, glue, adhesive, snaps, or hook and loop fasteners.

13. The material of claim 11 wherein said fastener permits pests to come into contact with an outside surface of said porous fabric layer.

14. The material of claim 13 wherein the object is selected from the group consisting of bedding, luggage, briefcase, tote bag, purse, bag, backpack, truck container, and sleeping bag.

15. The material of claim 11 comprising an adhesive and configured as a tape.

16. The material of claim 1 designed so that said pesticide will continue to be released throughout a predetermined lifetime of the material.

17. The material of claim 1 wherein said material at least partially comprises Tyvek® or a satin or satin-like material.

18. A method of manufacturing a material for controlling pests, the method comprising:
disposing a pesticide on batting; and
quilting the batting between two fabric sheets;
wherein at least one of the fabric sheets is porous to the pesticide.

19. The method of claim 18 wherein the quilting step is performed using a quilter, a seam welder, or an ultrasonic bonding machine.

20. The method of claim 18 wherein the disposing step comprising spraying a liquid or powder pesticide on the batting.

21. The method of claim 18 further comprising the at least one porous fabric sheet controllably releasing the pesticide.

22. The method of claim 21 wherein controllably releasing the pesticide comprises ensuring that pesticide will continue to be released throughout a predetermined lifetime of the material.

23. The method of claim 18 further comprising sealing the material along at least a portion of the edges of the material.

24. The method of claim 18 further comprising disposing a fastener on the material.

25. The method of claim 24 wherein configuration of the fastener permits pests to access an outside surface of the at least one porous fabric sheet.
